(19) United States
(12) Patent Application Publication
(10) Pub. No.: US 2014/0157096 A1
(43) Pub. Date: Jun. 5, 2014

(54) SELECTING VIDEO THUMBNAIL BASED ON SURROUNDING CONTEXT

(71) Applicant: INTERNATIONAL BUSINESS MACHINES CORPORATION, Armonk, NY (US)

(72) Inventors: Paula Besterman, Cary, NC (US); Joseph Leong, West Lafayette, IN (US); Adrian X. Rodriguez, Durham, NC (US); Pamela S. Ross, Raleigh, NC (US); Eric Woods, Durham, NC (US)

(73) Assignee: INTERNATIONAL BUSINESS MACHINES CORPORATION, Armonk, NY (US)

(21) Appl. No.: 13/705,904

(22) Filed: Dec. 5, 2012

(51) Int. Cl. G06F 17/21

(52) U.S. Cl. CPC G06F 17/211
USPC 715/209

(57) ABSTRACT

Some embodiments of the inventive subject matter include a computer program product for determining a thumbnail image for a video. The computer program product can include computer usable program code configured to analyze the video. The computer usable program code can be further configured to determine video themes based on the analyzing the video. The computer usable program code can be further configured to produce a first group of thumbnail images for the video themes. The computer usable program code can be further configured to determine a forum theme for an electronic forum in which the video will be accessible. The computer usable program code can be further configured to choose, from the first group of thumbnail images, a matching thumbnail image that is thematically consistent with the forum theme. The computer usable program code can be further configured to present the matching thumbnail image in the forum.

### BACKGROUND

Embodiments of the inventive subject matter generally relate to the field of displaying media on the internet, and more particularly to the display of video thumbnails selected to correspond with a website's content.

In the context of website content, “thumbnail image” typically refers to a smaller image that represents a larger image. Thumbnails can represent static images. Thumbnail images can also represent videos and other media. In many instances, it is important that a thumbnail image (a.k.a. “thumbnail) accurately represents media with which it is associated.

Commonly, thumbnails are associated with search results provided by a search engine. Typically, when a user enters search term(s) into a search engine, the search engine returns a list relevant links, media, and the like. In the context of image and video searches, a search engine may display thumbnails of the media associated with the search result. For example, an image search may yield a plurality of thumbnails associated with media relevant to the search terms. The thumbnails are typically reduced-size representations of the original images. Similarly, a video search may yield a plurality of thumbnails associated with media relevant to the search terms. Unlike a static image (i.e., a single image), a video is a sequence of many images. As such, the thumbnail representing the video is a reduced-size representation of one of the many images that make up the video (e.g., the thumbnail is a frame in the video). Because a thumbnail for a video is only one (or a handful) of the many frames that make up the video, it may be desirable for the thumbnail to be a frame accurately representing the video as a whole. For example, a frame depicting the Olympic Rings as a thumbnail for a video discussing the Olympic Games may be more representative of the content than a frame depicting scenery of a city hosting the Olympic Games.

### SUMMARY

Some embodiments of the inventive subject matter may include a method for embedding, in a website, a video and a thumbnail image associated with the video. The method can include requesting, over a network, the video from a video source. The method can include transmitting, to the video source, theme information indicating a theme of the website. The method can include receiving the video and the thumbnail image, wherein the thumbnail image is thematically consistent with the theme of the website. The method can include embedding the video in the website. The method can include presenting the thumbnail image in association with the video.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a web browser 100 containing theme elements 104-108 and a thumbnail 102.

FIG. 2 is a block diagram of a network 200 over which a video thumbnail selection device could operate.

FIG. 3 is a flow diagram illustrating operations for receiving thumbnails appropriate to a website's theme from a host website.

FIG. 4 is a flow diagram illustrating operations for determining an appropriate thumbnail based on the theme of a website.

FIG. 5 depicts an example video thumbnail selection device 500.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to a website (whether a host website or an embedding website) analyzing existing metadata for the video to determine an appropriate thumbnail, in other embodiments, the website (whether a host website or an embedding website) may generate the relevant metadata itself In other instances, well-known instruction instances, protocols, structures and techniques have not been shown in detail in order not to obfuscate the description.

Currently, video thumbnails are typically selected by default as the first frame of the video. Sometimes the author, or person posting a video, may select a video frame that they wish to use as the video's thumbnail. If the thumbnail is chosen as the first frame of the video by default, the thumbnail may not accurately represent the subject matter of the video. For instance, if a video begins by displaying the author of the video, or a copyright notice, using this image as the video's thumbnail is unlikely to represent the video's subject matter. If the author/poster chooses a thumbnail, it is more likely to represent the subject matter of the video.

Often times, videos are shared or reposted on different websites. When a video is reposted, it typically retains its current thumbnail (whether selected by default or selected by the author/poster). This can be problematic, as different websites may focus on different information. As such, a different thumbnail may be desirable for the same video, depending on the website or forum on which it is presented. For example, a video filmed in the rainforest may be posted to a nature television channel website. When posted to a rainforest preservation blog, the video thumbnail could include images of deforestation. When posted to a wildlife website, the video thumbnail could include images of animals. The inventive subject matter may allow video thumbnails to be selected based on the content or the context of the forum on which the video is presented. As such, the thumbnail may accurately represent the video, and may be relevant to the interests of the visitors of the forum.

In one embodiment, a website or forum that will be embedding (or posting) the video (e.g., the “embedding website”) may begin by requesting the video from a video source (e.g., a source website). Next, the embedding website may communicate to the source website information about the embedding website's theme. After the source website receives the theme information from the embedding website, the source website can determine a number of possible thumbnails, and provide the thumbnails to the embedding website along with the video. In other embodiments, the embedding website itself may analyze the contents of the video. Upon reviewing the contents of the video, the embedding website may select an appropriate frame (or frames) suitable to act as a thumbnail (or thumbnails) for the video. In any case, some embodiments of the inventive subject matter select thumbnails for videos and other media content.

The present embodiments may be better understood, and numerous objects, features, and advantages made apparent to those skilled in the art by referencing the accompanying drawings.

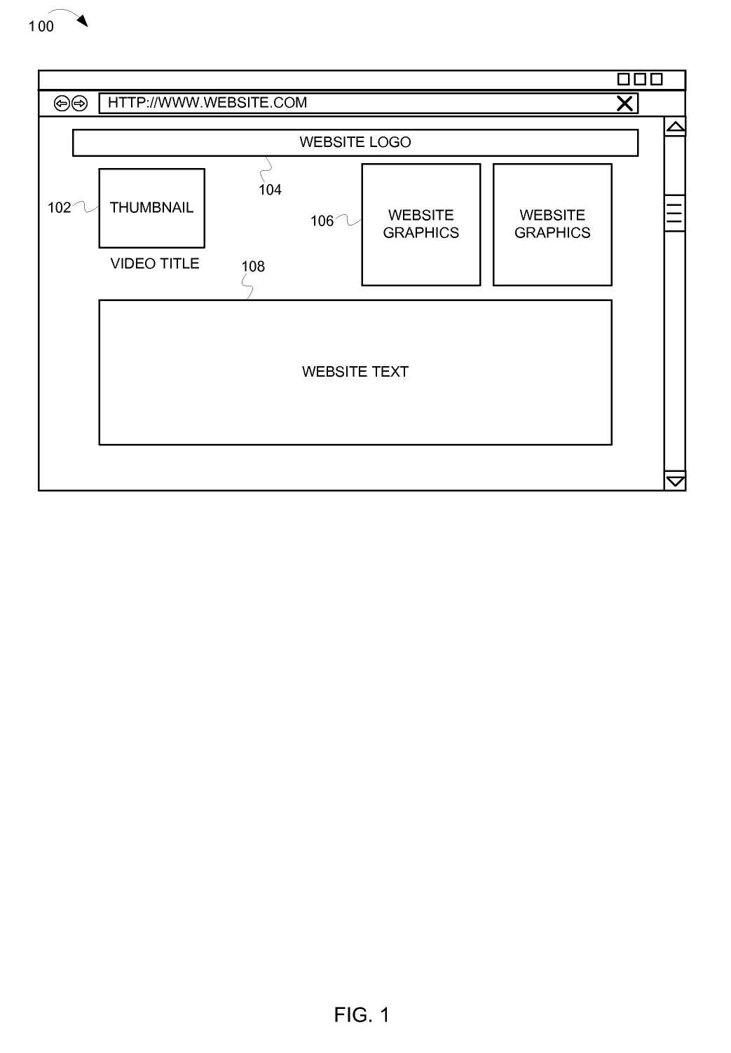

FIG. 1 depicts a web browser 100 containing theme elements 104-108 and a thumbnail 102. In FIG. 1, an illustrative example of a web browser window 100 is shown. The elements of the website, including but not limited to, the website logo 104, website graphics 106, and the website text 108 represent content which may establish a theme for the website. An appropriate video thumbnail 102 may be selected based on the theme of the website. In some embodiments, a theme can be based on aesthetic qualities of the website as well as its content. For example, if the website is organized around a “blue theme,” a frame that is predominantly blue could be selected as the thumbnail.

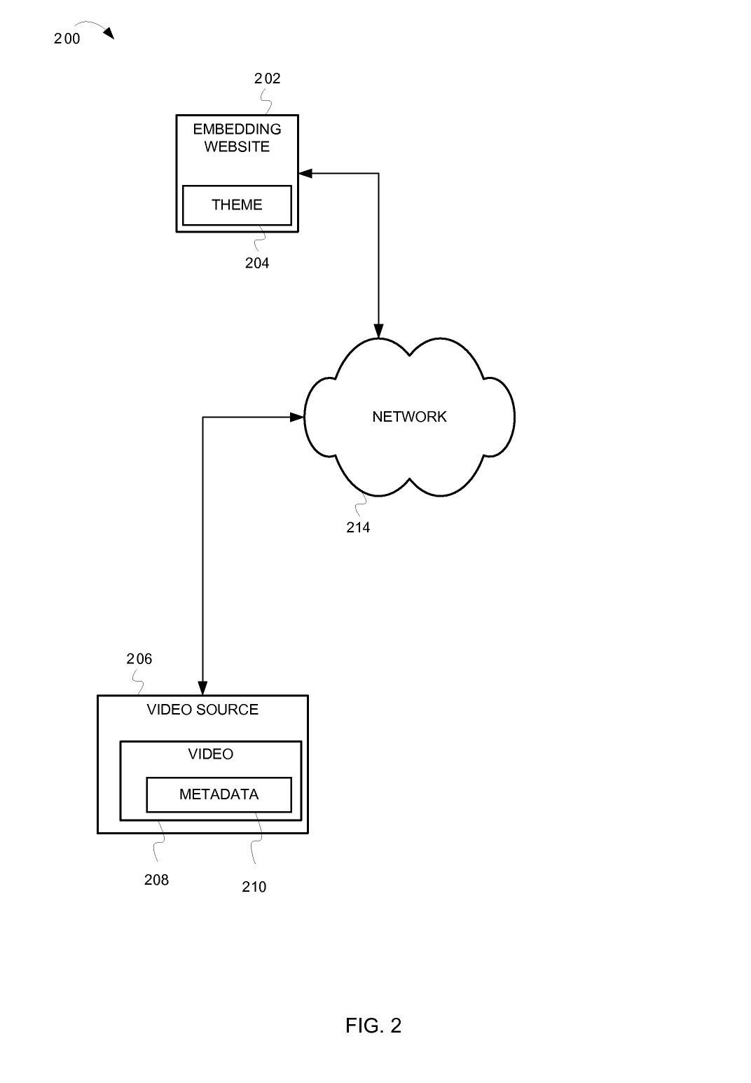

FIG. 2 is a block diagram of a network 200 over which a video thumbnail selection device could operate. In FIG. 2, an embedding website 202 includes elements which make up a theme 204 for the embedding website 202. The embedding website 202 interacts with the video source 206 over a network 214. The video source 206 contains a video 208. In some embodiments, the video source 206, in addition to video, contains metadata 210 associated with the video 206. In such an embodiment, the embedding website 202 may transmit information about its theme 204 over the network 214 to the video source 206. The video source website 206 may then, based on the embedding website's 202 theme, select an appropriate thumbnail from the video 208 by analyzing the video's 208 metadata 210. Alternatively, in other embodiments, the embedding website may perform operations for selecting a thumbnail for the video. For example, the embedding website 202 may analyze the video 208 and create metadata 210 for the video 208. In such embodiments, the embedding website 202 itself may then use the metadata 210 to select an appropriate thumbnail. In yet other embodiments, the video source 206 may transfer both the video 208 and the metadata 210 to the embedding website 202. The embedding website 202 can then analyze the metadata 210 (created by the video source) to select an appropriate thumbnail for the video 208.

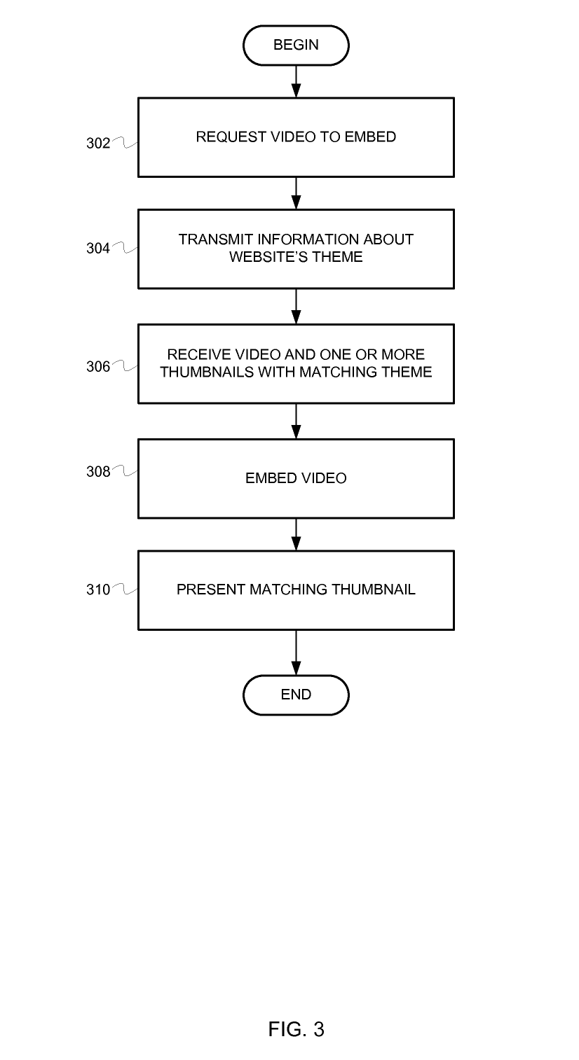

FIG. 3 is a flow diagram illustrating operations for receiving thumbnails appropriate to a websites theme from a host website or other video source. The flow begins at block 302. At block 302, the embedding website requests a video to embed. In some embodiments, the embedding website may request a video from a video source (e.g., another website). In other embodiments, the embedding website may retrieve a video from a local source. The flow continues at block 304.

At block 304, the embedding website transmits information about its theme to the video source website. The video source website can use the theme information to select video thumbnail images that complement the embedding website's theme. In some embodiments, where the video originates from a local source, this operation may be unnecessary. The flow continues at block 306.

At block 306, the embedding website receives the video and one or more suitable thumbnails from the host website or video source. As noted, the thumbnails complement or otherwise work with the embedding website's theme. The flow continues at block 308.

At block 308, the embedding website embeds the video. The flow continues at block 310.

At block 310, the embedding website presents the appropriate thumbnail which may match the website's theme.

This description continues with a discussion about how the video source may select thumbnails based on information provided by the embedding website.

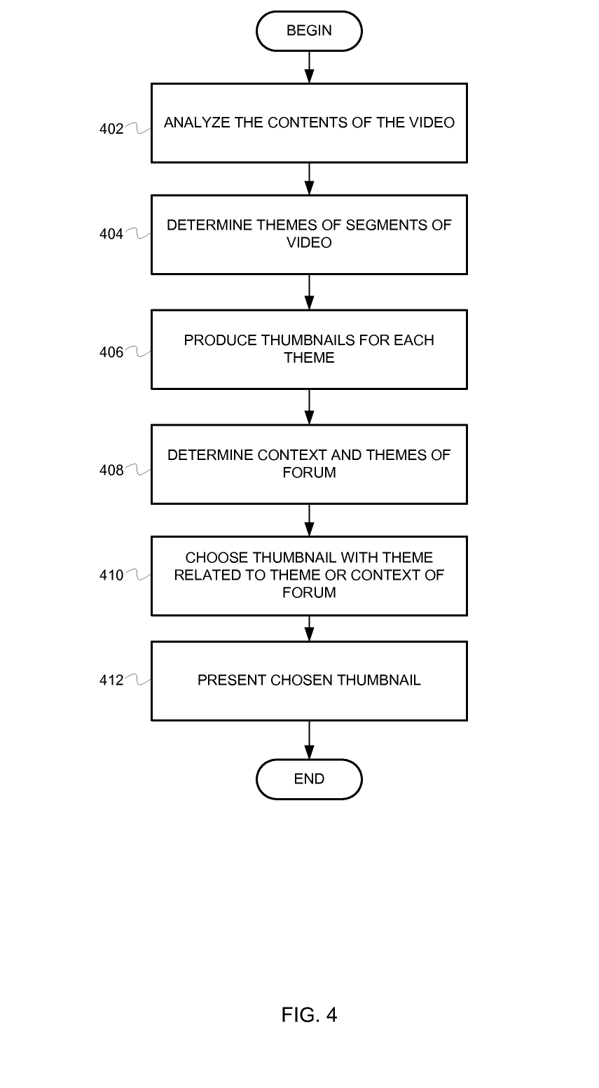

FIG. 4 is a flow diagram illustrating operations for determining an appropriate thumbnail based on the theme of a website. The flow begins at block 402. At block 402, the embedding website analyzes the contents of the video. The flow continues at block 404.

At block 404, the embedding website determines distinct segments of the video. The embedding website then determines the themes of each distinct segment. The flow continues at block 406.

At block 406, the embedding website produces thumbnails appropriate to each of the video's segment themes, i.e. thumbnails that may be descriptive of each segment theme. The flow continues at block 408.

At block 408, the embedding website determines context and themes of the forum. In some embodiments, the embedding website may be the forum. As such, the embedding website would determine its own themes. The flow continues at block 410.

At block 410, the embedding website chooses a thumbnail that has a theme consistent with the theme of the forum. As noted, the thumbnails complement or otherwise work with the embedding website's theme. The flow continues at block 412.

At block 412, the embedding website presents the chosen thumbnail.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

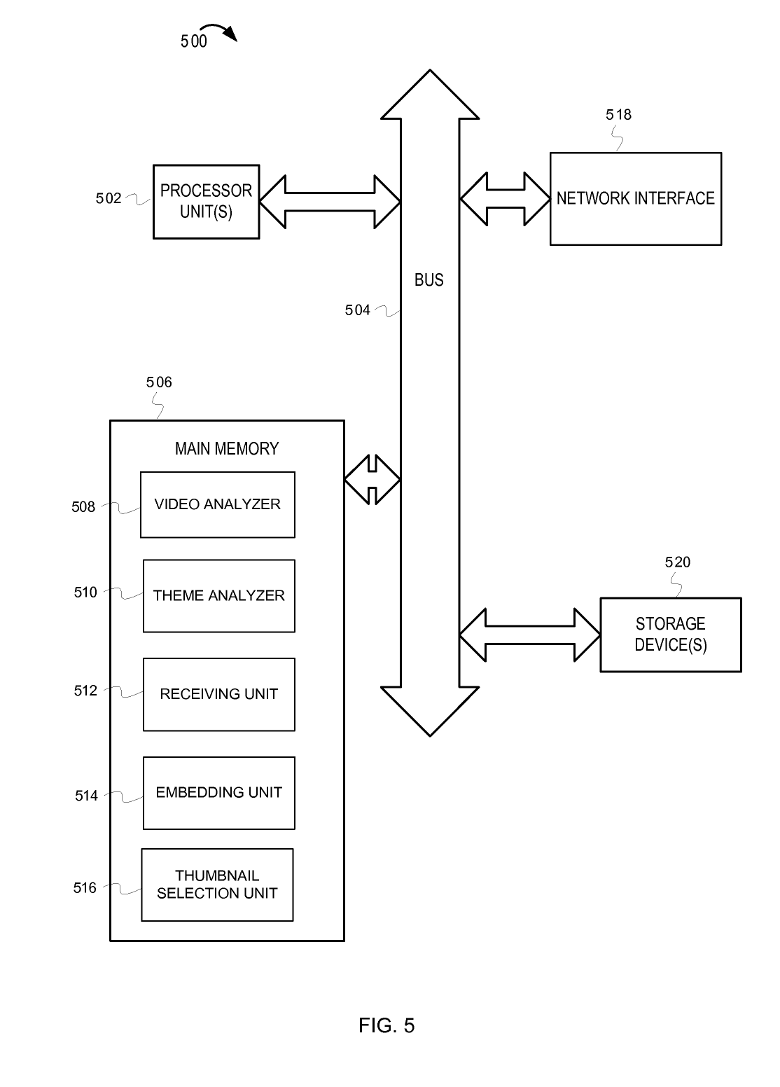

FIG. 5 depicts an example video thumbnail selection device 500. The exemplary video thumbnail selection device 500 includes a processor unit 502 (possibly including multiple processors, multiple cores, multiple nodes, and/or implementing multi-threading, etc.). The video thumbnail selection device includes memory 506. The memory 506 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The video thumbnail selection device also includes a bus 504 (e.g., PCI, ISA, PCI-Express, HyperTransport®, InfiniBand®, NuBus, etc.), a network interface 518 (e.g., an ATM interface, an Ethernet interface, a Frame Relay interface, SONET interface, wireless interface, etc.), and a storage device(s) 520 (e.g., optical storage, magnetic storage, etc.). The system memory 506 embodies functionality to implement the embodiments described above. The system memory includes a video analyzer 508, a theme analyzer 510, a receiving unit 512, an embedding unit 514, and a thumbnail selection unit 516. In some embodiments, the receiving unit 512 receives the video from the host website or other video source. In other embodiments, the receiving unit 512 can receive both the video and metadata or other content, associated with the video. In some embodiments, the video analyzer 508 may analyze the video to determine the theme(s) of the video. In other embodiments, the video analyzer 508 may analyze metadata, or other content, provided to it to determine the themes of the video. In some embodiments, the theme analyzer 510 can analyze the theme of the embedding website or the forum to which the video is to be posted. The thumbnail selection unit 516 can determine an appropriate thumbnail for the video based on the theme of the video and the theme of the embedding website or forum. The embedding unit 514 can embed the video in the embedding website or other forum. Any one of these functionalities may be partially (or entirely) implemented in hardware and/or on the processing unit 502. For example, the functionality may be implemented with an application specific integrated circuit, in logic implemented in the processing unit 502, in a co-processor on a peripheral device or card, etc. Further, realizations may include fewer or additional components not illustrated in FIG. 5 (e.g., video cards, audio cards, additional network interfaces, peripheral devices, etc.). The processor unit 502, the storage device(s) 520, and the network interface 518 are coupled to the bus 504. Although illustrated as being coupled to the bus 504, the memory 506 may be coupled to the processor unit 502.

While the embodiments are described with reference to various implementations and exploitations, it will be understood that these embodiments are illustrative and that the scope of the inventive subject matter is not limited to them. In general, techniques for video thumbnail selection as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1.-13. (canceled)

14. A computer program product for determining a thumbnail a matching thumbnail image for a video, the computer program product comprising:
a computer readable storage medium having computer usable program code embodied therewith, the computer usable program code comprising a computer usable program code configured to:
analyze the video;
determine video themes based on the analyzing the video;
produce a first group of thumbnail images for the video themes;
determine a forum theme for an electronic forum in which the video will be accessible;
choose, from the first group of thumbnail images, a matching thumbnail image that is thematically consistent with the forum theme; and
present matching thumbnail image in the forum.

15. The computer program product of claim 14, wherein the forum theme is determined by aesthetic aspects of the forum.

16. The computer program product of claim 14, wherein the forum theme is determined by textual content of the forum.

17. The computer program product of claim 14, wherein the forum theme is determined by visual content of the forum.

18. The computer program product of claim 14, wherein the video themes are stored as metadata.

19. The computer program product of claim 14, wherein the one or more video themes are stored as metadata for later use.

20. The computer program product of claim 14, further configured to:
determine that the forum theme has changed to a second forum theme;
choose, from the first group of thumbnail images, a second matching thumbnail image that is thematically consistent with the second forum theme; and
present the second matching thumbnail image in the forum.
